(19) United States
(12) Patent Application Publication
(10) Pub. No.: US 2025/0217930 A1
(43) Pub. Date: Jul. 3, 2025

(54) COMPACTLY CONSTRUCTING HIERARCHICAL HISTOGRAMS

(71) Applicant: AirMettle, Inc., Houston, TX (US)

(72) Inventors: Donpaul C. Stephens, Houston, TX (US); Mohit Anand, Dallas, TX (US)

(21) Appl. No.: 18/650,669

(22) Filed: Apr. 30, 2024

Related U.S. Application Data
(60) Provisional application No. 63/617,273, filed on Jan. 3, 2024.

(51) Int. Cl. G06T 5/40; G06F 16/22

(52) U.S. Cl. CPC G06T 5/40; G06F 16/2246

(57) ABSTRACT

A technique of generating histograms includes providing data elements in a uniform binary format as multiple consecutive chunks, where each chunk includes a sequence of consecutive binary digits. The technique includes placing the data elements in nodes of a tree based on the chunks. The nodes are arranged in successive levels that correspond to successive chunks. Each node counts the data elements placed in that node and in any child node of that node at lower levels of the tree. The technique further includes traversing one or more nodes of the tree to generate a histogram of the data elements counted by that node or nodes.

### BACKGROUND

Histograms are common tools for facilitating data analysis, visualization, and interpretation. A simple histogram may be realized as a bar graph that identifies different values or ranges on one axis and numbers of occurrences of those values or ranges on another axis. For example, a histogram for visualizing snowfall could provide one bar that represents the number of days having between 0 and 2 cm of snow, another bar that represents the number of days having between 2 cm and 4 cm of snow, another bar that represents the number of days having between 4 cm and 6 cm of snow, and so on.

Histograms are not limited to a single dimension. A two-dimensional histogram could display snowfall within different two-dimensional regions on a map, where such regions are defined by both latitude ranges and longitude ranges. Indeed, histograms may represent data across any number of dimensions.

To generate a histogram, a computer may receive a dataset and create multiple bins for different ranges of a variable to be counted. The computer than iterates through the dataset, incrementing counts for the individual bins based on the numbers of occurrences found in the dataset of values falling within the bins' ranges. Once the computer has completed its pass through the dataset, the computer may present the results in graphical form, e.g., with ranges of the bins identified on one or more horizontal axes and numbers of occurrences (e.g., bars) of the variable extending along a vertical axis.

### SUMMARY

Unfortunately, the above-described approach to generating histograms can be inflexible and inefficient. For example, the prior approach relies upon having up-front knowledge about the particular bins to be used for collecting counts. If a user creates a histogram and then wishes to change the way the data are binned, or wishes to try out different binning scenarios, the binning process may have to be rerun each time from scratch, thus multiplying the computational workload involved. In addition, users sometimes wish to visualize their histograms at different levels of granularity. Coarse histograms may satisfy certain user needs, whereas more finely resolved histograms may satisfy other needs. Prior schemes may require an additional pass through the dataset each time a different binning granularity is desired, however. What is needed, therefore, is a more flexible and efficient way of generating histograms.

To address the above need at least in part, an improved technique of generating histograms includes providing data elements in a uniform binary format as multiple consecutive chunks, where each chunk includes a sequence of consecutive binary digits. The technique includes placing the data elements in nodes of a tree based on the chunks. The nodes are arranged in successive levels that correspond to successive chunks. Each node counts the data elements placed in that node and in any child node of that node at lower levels of the tree. The technique further includes traversing one or more nodes of the tree to generate a histogram of the data elements counted by that node or nodes.

Advantageously, the same tree can be used for generating multiple histograms, without having to make additional passes through the data. Rather, the nodes count occurrences hierarchically, with each node aggregating the counts of its child nodes. Generating new histograms can thus involve traversing only the nodes needed for obtaining counts at the desired level of granularity, which may include fewer than all the nodes in the tree.

Certain embodiments are directed to a method of generating histograms. The method includes providing a plurality of data elements in a uniform binary format that represents each data element as a plurality of consecutive chunks, each chunk defining a sequence of consecutive binary digits. The method further includes placing the plurality of data elements in nodes of a tree based on the plurality of chunks. The nodes of the tree are arranged in successive levels that correspond to successive chunks of the plurality of chunks. Each node counts data elements placed in that node and in any child nodes of that node at lower levels of the tree. The method still further includes traversing a set of nodes of the tree to generate a histogram of the data elements counted by the set of nodes.

In some examples, the set of nodes is a first set of nodes, and the method further includes, without modifying any nodes of the tree, traversing a second set of nodes of the tree to generate a second histogram, the second set of nodes including a level of the tree that is not included in the first set of nodes.

In some examples, a most-significant chunk of the plurality of chunks includes N bits that specify 2^{N} binary values, and placing the plurality of data elements includes: providing a root node of the tree that includes 2^{N} buckets and 2^{N} counters, one bucket and one counter for each of the 2^{N} binary values; storing a first data element of the plurality of data elements in a first bucket of the 2^{N} buckets, the first bucket selected based on a most-significant N bits of the first data element; and incrementing the counter provided for the first bucket.

In some examples, the root node further includes a first tracking structure having 2^{N} elements, one element for each of the 2^{N} binary values, and wherein placing the plurality of data elements further includes marking the first bucket as populated in the first tracking structure.

In some examples, placing the plurality of data elements further includes determining that an additional data element of the plurality of data elements matches the first data element and, in response to the determination, incrementing the counter provided for the first bucket.

In some examples, placing the plurality of data elements further includes storing a second data element of the plurality of data elements in a second bucket of the 2^{N} buckets different from the first bucket, based on (i) a most-significant N bits of the second data element matching the most-significant N bits of the first data element and (ii) the second data element differing from the first data element at other bit locations, and incrementing the counter associated with the second bucket.

In some examples, the root node further includes a second tracking structure having 2^{N} elements, one for each of the 2^{N} binary values, and placing the plurality of data elements further includes marking the second bucket as visited in the second tracking structure, the visited marking indicating that the second bucket was not provided for the most-significant N bits of the second data element.

In some examples, the root node is disposed at a first level of the tree, and placing the plurality of data elements further includes storing a third data element of the plurality of data elements in a child node of the root node disposed at a second level of the tree, storing a pointer to the child node in a third bucket of the 2^{N} buckets, incrementing the counter associated with the third bucket, and incrementing a counter associated with the child node, wherein the child node is configured to store or point to data elements of the plurality of data elements whose most-significant N bits are all the same.

In some examples, the root node further includes a third tracking structure having 2^{N} elements, one for each of the 2^{N} binary values, and placing the plurality of data elements further includes marking the third bucket as branched in the third tracking structure, the branched marking indicating that the third bucket stores the pointer to the child node.

In some examples, providing the plurality of data elements includes receiving a plurality of floating-point numbers, each floating-point number including a sign bit, multiple exponent bits, and multiple fraction bits, and converting the plurality of floating-point numbers into at least some of the plurality of data elements having the uniform binary format. The converting includes, for each of the plurality of floating-point numbers, providing an exponent-sign bit that represents a sign of an exponent of the floating-point number, and modifying the exponent bits to represent the exponent as an unsigned value.

In some examples, modifying the exponent bits includes subtracting a bias from the exponent of each floating-point number having a positive exponent.

In some examples, modifying the exponent bits includes subtracting the exponent from the bias and adding 1 for each floating-point number having a negative exponent.

In some examples, converting the plurality of floating-point numbers includes grouping together the modified exponent bits with the fraction bits of each floating-point number and transforming the grouped bits into a shortened sequence that includes an M-bit magnitude value and a P-bit precision value.

In some examples, transforming the grouped bits includes, for a first floating-point number of the plurality of floating-point numbers, identifying a bit position of a most-significant 1 that appears within a most-significant 2^{M}−1 bits of the grouped bits, converting the bit position of the most-significant 1 to the M-bit magnitude value that represents the bit position of the most-significant 1, identifying the P-bit precision value as a P-bit sequence in the grouped bits that immediately follows the bit position of the most-significant 1, and concatenating the M-bit magnitude value with the P-bit precision value.

In some examples, transforming the grouped bits includes, for a second floating-point number of the plurality of floating-point numbers, determining that none of a most-significant 2^{M}−1 bits of the grouped bits is a 1, in response to said determining, assigning the M-bit magnitude value to all 1's, identifying the P-bit precision value as a P-bit sequence that begins at the (2^{M})-th bit position of the grouped bits, and concatenating the M-bit magnitude value with the P-bit precision value.

In some examples, converting the plurality of floating-point numbers into said at least some of the plurality of data elements having the uniform binary format further includes concatenating together the sign bit, the exponent-sign bit, the M-bit magnitude value, and the P-bit precision value.

In some examples, the method further includes storing a header with the tree, the header indicating a respective count of each of the following special number types: positive infinity; negative infinity, at least one type for zero, and not a number (NaN).

In some examples, providing the plurality of data elements includes receiving a plurality of integer numbers and converting the plurality of integer numbers into at least some of the plurality of data elements having the uniform binary format, said converting including, for each integer number of the plurality of integer numbers: generating an M-bit magnitude value as one of (i) a bit position of a most-significant 1 within a most-significant (2^{M}−1) bits of the integer number, responsive to the most-significant 1 existing or (ii) all 1's responsive to the most-significant 1 not existing; generating a P-bit precision value as one of (i) a P-bit sequence that immediately follows the most-significant 1, responsive to the most-significant 1 existing or (ii) a P-bit sequence beginning at the (2^{M})-th bit position of the integer number responsive to the most-significant 1 not existing; and concatenating the M-bit magnitude value with the P-bit precision value.

In some examples, providing the plurality of data elements includes receiving a plurality of floating-point numbers, receiving a plurality of integer numbers, converting the plurality of floating-point numbers into a first subset of the plurality of data elements having the uniform binary format, converting the plurality of integer numbers into a second subset of the plurality of data elements having the uniform binary format.

In some examples, converting the plurality of integer numbers into the second subset of the plurality of data elements includes transforming the plurality of integer numbers into a second plurality of floating-point numbers and transforming the second plurality of floating-point numbers into the uniform binary format.

In some examples, the tree is a first subtree of multiple subtrees, the plurality of data elements is part of a multiplicity of data elements, the data elements represent multidimensional data in which a number is provided for each dimension of each data element, and the method further includes: assigning a top-level encoding (TLE) to the number provided for each dimension of each data element of the multiplicity of data elements, the TLE being a binary value that identifies a type of the number from among multiple types of numbers; generating a combined TLE for each data element by concatenating the TLE assigned to the number provided for each dimension with the TLE assigned to the number provided for each other dimension of that data element; assigning data elements to buckets of a top-level structure based on combined TLEs, such that each bucket of the top-level structure is provided for a respective value of combined TLEs; and counting data elements assigned to each bucket.

In some examples, the method further includes providing a respective subtree for each bucket to which more than one data element is assigned.

In some examples, the method further includes arranging data elements that store multidimensional data by interleaving bits of numbers in one dimension with bits of numbers in each of the other dimensions.

In some examples, the types of numbers include special numbers and non-special numbers, and the method further includes assigning a respective subtree to each bucket for which the combined TLE includes at least one TLE for a non-special number.

In some examples, the method further includes arranging data elements that store multidimensional data by removing dimensions containing special numbers from the data elements and interleaving bits of numbers in one unremoved dimension with bits of numbers in each of the other unremoved dimensions.

In some examples, the method further includes compacting the tree to remove unused buckets and counts.

In some examples, traversing the set of nodes to generate the histogram of the data elements counted by the set of nodes includes: receiving a query that requests a total count of all data elements between a first data element and a last data element; establishing an initial running total based at least in part on a set of first-leaf counts appearing in a first leaf node after a first count associated with the first data element; adding to the running total a set of last-leaf counts appearing in a last leaf node before a last count associated with the last data element; adding to the running total at least one aggregated count obtained from a lowest common node at a level of the tree higher than the first leaf node and the second leaf node; and returning the running total in response to the query.

In some examples, a multi-bit sorting value precedes the plurality of consecutive chunks in the uniform data format, and the method further includes providing, for each unique sorting value of data elements that are filed, a pointer to a root node of a respective tree, each respective tree constructed and arranged to file data elements having the sorting value as its most-significant bits.

Further embodiments are directed to methods, apparatus, and computer program products for transforming numbers for filing in a histogram tree, such as numbers expressed with unbiased exponents, numbers expressed with precision bits and magnitude bits, and/or numbers expressed with both unbiased exponents and precision and magnitude bits. Such embodiments may be combined with any of the embodiments described above or may be entirely independent of such embodiments.

Further embodiments are directed to methods, apparatus, and computer program products for filing multidimensional data elements, including sorting numbers according to respective types of numbers in respective dimensions, and filing data elements based on respective combinations of types. Such embodiments may be combined with any of the embodiments described above or may be entirely independent of such embodiments

Other embodiments are directed to a computerized apparatus constructed and arranged to perform a method of generating histograms, such as the method described above. Still other embodiments are directed to a computer program product. The computer program product stores instructions which, when executed on control circuitry of a computerized apparatus, cause the computerized apparatus to perform a method of generating histograms, such as the method described above.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is a block diagram of an example environment in which embodiments of the improved technique can be practiced.

FIG. 2 is a block diagram of an example root node of a histogram tree according to some embodiments.

FIG. 3 is a block diagram of example child nodes of the histogram tree according to some embodiments.

FIG. 4 is a block diagram showing an example arrangement for preparing exponents of floating-point numbers for filing in the histogram tree according to some embodiments.

FIG. 5 is a flowchart showing an example method of preparing exponents of floating-point numbers for filing in the histogram tree according to some embodiments.

FIG. 6 is a block diagram showing an example arrangement for representing floating-point numbers using magnitude bits and precision bits according to some embodiments.

FIG. 7 is a flowchart showing an example method of preparing integer numbers for filing in the histogram tree according to some embodiments.

FIG. 8 is a table showing an example arrangement for assigning a top-level encoding (TLE) to numbers based on their types according to some embodiments.

FIG. 9 is a block diagram showing an example top-level structure for organizing multidimensional data that contain numbers of various types according to some embodiments.

FIG. 10 is a block diagram showing an example arrangement for preparing multidimensional data for filing according to some embodiments.

FIG. 11 is a block diagram of an example sorting level, which may be placed above root nodes in some embodiments.

FIG. 12 is a block diagram showing an example application of sorting levels applied to multidimensional data elements according to some embodiments.

FIG. 13 is a block diagram showing an example compaction procedure that may be used with tree structures having populated bitmaps according to some embodiments.

FIG. 14 is a block diagram showing an example arrangement for responding to range queries according to some embodiments.

FIG. 15 is a flowchart showing an example method of generating histograms according to some embodiments.

### DETAILED DESCRIPTION

Embodiments of the improved technique will now be described. One should appreciate that such embodiments are provided by way of example to illustrate certain features and principles but are not intended to be limiting.

An improved technique of generating histograms includes providing data elements in a uniform binary format as multiple consecutive chunks, where each chunk includes a sequence of consecutive binary digits. The technique includes placing the data elements in nodes of a tree based on the chunks. The nodes of the tree are arranged in successive levels that correspond to successive chunks. Each node counts the data elements placed in that node and in any child node of that node at lower levels of the tree. The technique further includes traversing one or more nodes of the tree to generate a histogram of the data elements counted by that node or nodes.

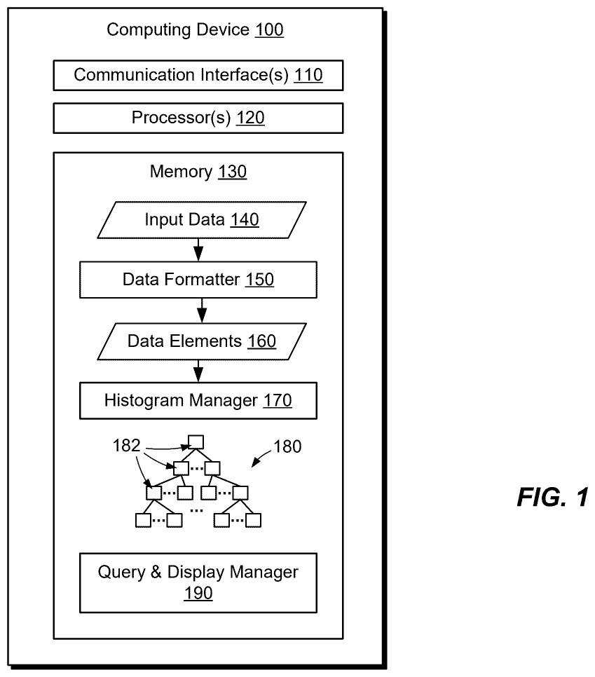

FIG. 1 shows an example computing device 100 in which embodiments of the improved technique can be practiced. The computing device 100 includes one or more communication interfaces 110, a set of processors 120, and memory 130. The communication interfaces 110 include, for example, one or more network interface adapters for communicating with one or more client computers (not shown). The set of processors 120 includes one or more processing chips, coprocessors, and/or assemblies. The memory 130 includes both volatile memory, e.g., RAM (Random Access Memory), and non-volatile memory, such as one or more ROMs (Read-Only Memories), disk drives, solid state drives, and the like. The set of processors 120 and the memory 130 together form control circuitry, which is constructed and arranged to carry out various methods and functions as described herein. Also, the memory 130 includes a variety of software constructs realized in the form of executable instructions. When the executable instructions are run by the set of processors 120, the set of processors 120 is made to carry out the operations of the software constructs. Although certain software constructs are specifically shown and described, it is understood that the memory 130 typically includes many other software components, which are not shown, such as an operating system, various applications, processes, and daemons. The computing device 100 may be realized in a variety of forms, such as a desktop computer, laptop computer, tablet computer, smart phone, personal data assistant, or the like, the particulars of which are not critical to this disclosure.

As further shown in FIG. 1, the memory 130 “includes,” i.e., realizes by execution of software instructions, a data formatter 150, a histogram manager 170, and a query and display manager 190. The data formatter 150 is configured to receive input data 140 and to render the input data as data elements 160 in a uniform binary format. The input data 140 may take various forms, such as floating-point numbers, integers, or combinations of floating-point numbers and integers.

The histogram manager 170 is configured to manage a histogram tree 180, which includes filing data elements 160 in the histogram tree 180 and counting data elements in nodes 182 of the tree 180. For example, the histogram manager 170 assigns data elements 160 to nodes 182 of the tree 180. Each node 182 counts not only the data elements 180 assigned directly to that node, but also data elements assigned to any child nodes of that node, from immediate child nodes all the way to leaf nodes. This hierarchical counting enables coarse histograms to be created from one or more higher-order nodes of the tree 180 without having to visit all of the lower-order nodes, thus promoting efficiency.

The query and display manager 190 is configured to access the tree 180 for executing queries and displaying histograms. In an example, queries may be expressed in SQL (Structured Query Language), such as SQL Select queries. In some examples, the query and display manager 190 is configured to display histograms hierarchically. For example, an initially-displayed histogram may be created by accessing only a root node of the tree 180 and displaying counts at the root node, e.g., using bars or other graphical regions. In some examples, the displayed histogram is interactive, such that a user can select a particular bar or region, e.g., by double-clicking. In response to the user selection, the query and display manager 190 may generate and display a finer-granularity histogram, based not only on the root node but also on one or more nodes at lower levels of the tree 180. Eventually, the user may drill down to the lowest (leaf) level, where data is presented at the finest available granularity.

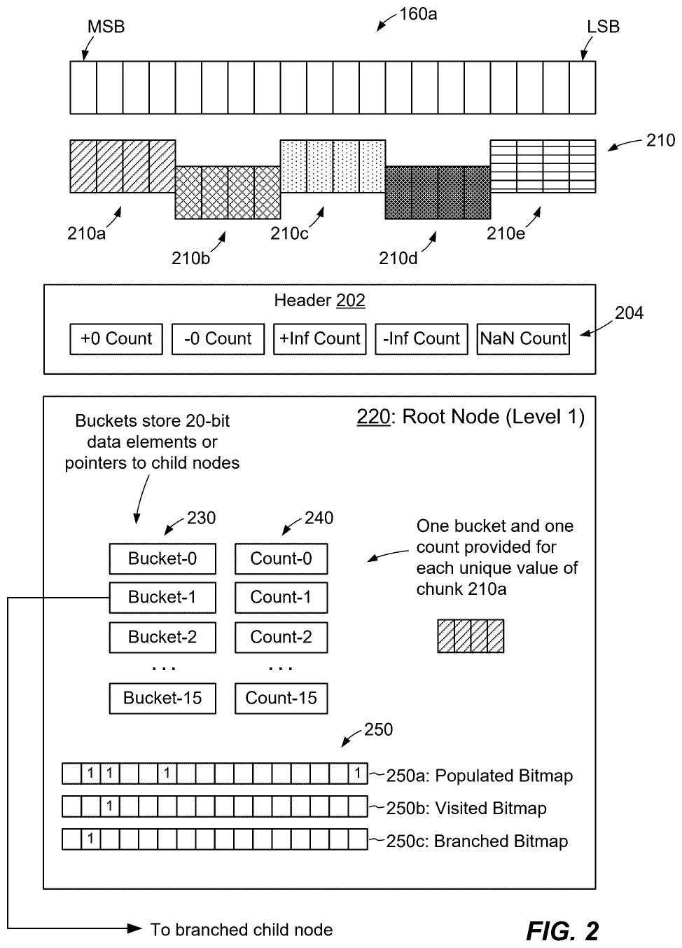

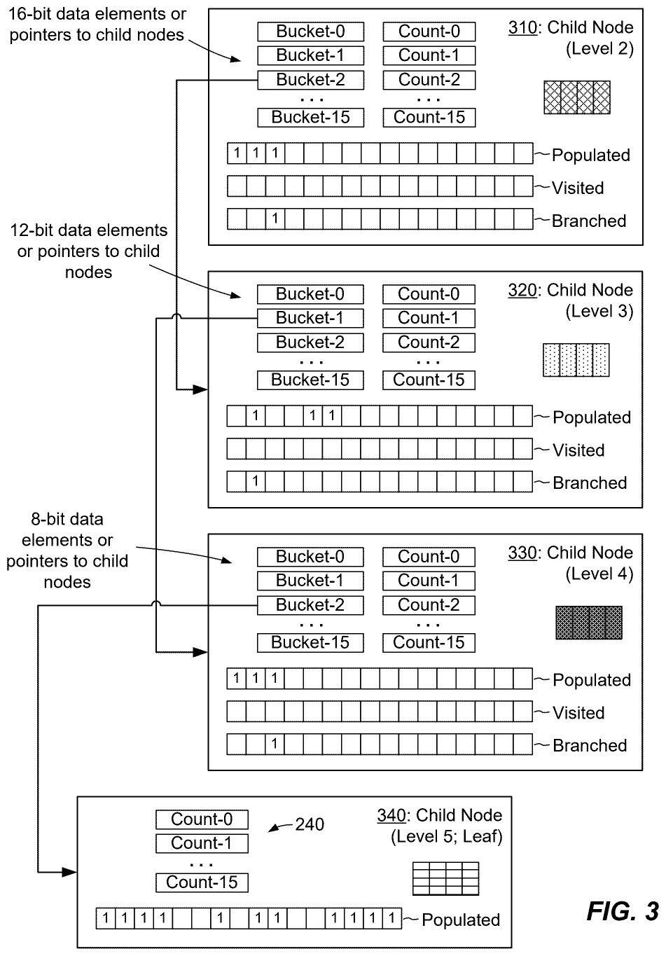

FIGS. 2 and 3 show an example arrangement for assigning data elements 160 to nodes 182 of the histogram tree 180. Starting with FIG. 2, a data element 160a is provided as a multi-bit binary value having a most-significant bit (MSB) and a least-significant bit (LSB). The data element 160a is intended to be representative of the data elements 160 of FIG. 1.

The data element 160a may be regarded as containing multiple chunks 210, with each chunk 210 including a sequence of bits. In the example, the data element 160a contains five chunks 210a, 210b, 210c, 210d, and 210e, with each chunk being 4 bits in size. However, the chunks 210 may have other sizes (e.g., 5 bits, 6 bits, etc.; powers of 2 are not required) and the chunks 210a through 210e need not all be the same size. Also, the size of the data element 160a need not be 20 bits, as shown, but may be larger or smaller. The number of chunks and the corresponding number of levels in the tree 180 may therefore vary. As described below, data elements 160 are assigned to nodes 182 of the tree 180 based on chunks 210.

As further shown in FIG. 2, a root node 220 (Level 1) of the tree 180 arranges data elements 160 based on values of the first chunk 210a. Here, the root node 220 includes 16 buckets 230 and 16 counters 240, one bucket 230 and one counter 240 for each unique value of the first chunk 210a (the illustrated 4-bit chunk has 24=16 unique values). The root node 220 also includes various tracking structures 250 realized as the following bitmaps: a “populated” bitmap 250a; a “visited” bitmap 250b; and a “branched” bitmap 250c. Each bitmap has one bit for each of the 16 buckets 230.

In example operation, the histogram manager 170 (FIG. 1) accesses the data elements 160 and begins filing them in the root node 220, based on values of the first (most-significant) chunk 210a. For example, assume that the histogram manager 170 accesses a first data element having a first chunk 210a with the value 15 (1111 in binary). After confirming that Bucket-15 is empty, the histogram manager 170 writes the first data element (e.g., all 20 bits) into Bucket-15. In an example, this writing is oblivious to the values of chunks 210b through 210e but rather is based entirely on the value of chunk 210a. At this time, the histogram manager 170 also increments the associated counter for Bucket-15, i.e., Count-15. The histogram manager 170 also sets the 15^{th} bit of the populated bitmap 250a. The populated bitmap 250a thus provides a convenient mechanism for determining whether buckets are populated or empty.

Assume now that the histogram manager 170 accesses one or more additional data elements and determines that such additional data elements are the same as the first data element stored in Bucket-15. In this case, the histogram manager 170 simply increments Count-15 by 1 for each such additional data element. No additional data storage is needed.

Assume further that the histogram manager 170 accesses a second data element for filing. This time, the first chunk 210a of the second data element is 5 (0101 in binary). The histogram manager 170 checks whether Bucket-5 is available, e.g., by checking the fifth bit position of the populated bitmap 250a. In this case, a previously-processed data element has already been stored in Bucket-5. The histogram manager 170 then checks whether the entire 20-bit value of the second data element matches the entire 20-bit data element already stored in Bucket-5. Assuming that the two 20-bit values do NOT match, the histogram manager 170 looks for a free bucket elsewhere. The histogram manager 170 determines that Bucket-2 is available, writes the entire second data element (all 20 bits) into Bucket-2, and increments Count-2. The histogram manager 170 also sets the bit-2 position of the populated bitmap 250a. Because Bucket-2 is not the natural place to store a data element whose first chunk 210a is 5, the histogram manager 170 also marks the bit-2 position of the visited bitmap 250b. This marking indicates that the first chunk 210a of the data element stored in Bucket-2 is not 2, but rather something different, such that Bucket-2 is being “visited.”

The ability to store data elements 160 in visited buckets may seem counterintuitive, but it provides certain advantages. Chief among these is dense packing of data elements 160 as high in the tree 180 as practicable. If visited locations were not permitted, the new entry would necessitate branching to a lower level of the tree, which would entail additional storage space and processing. Although branching may still occur for some data elements stored in visited buckets, branching may not be needed for all such data elements, and computing resources are conserved for these cases.

Continuing with the above example, further assume that sometime later a third data element is accessed for filing. Here, the third data element has a first chunk 210a equal to 8 (1000 in binary). Assume, however, that Bucket-8 is already populated with a data element having a different value and that no other buckets 230 are available. Thus, none of the buckets 230 are available for storing the third data element. In this case, the histogram manager 170 uses branching to create a new child node.

In an example, the histogram manager 170 proceeds smartly by identifying a set of buckets 230 that can be consolidated so as to create the largest number of free buckets in the root node 220. For example, assume that the histogram manager 170 determines that Bucket-1, Bucket-6, and Bucket-7 all store data elements having the same value of the first chunk 210a (because at least two of these buckets are visited). The histogram manager 170 then proceeds by consolidating the three buckets (1, 6, and 7) into a new child node that is a child of Bucket-1, for example. Buckets 6 and 7 are then freed. Rather than storing the value of a data element, Bucket-1 is updated to store a pointer to the new child node. The child node may then store the three different values of the now-consolidated buckets in separate buckets of the child node, which is organized based on the second chunk 210b. The associated counters in the child node are updated. So is the counter associated with branched bucket in the root node 220. To identify the branching, the histogram manager 170 sets the bit-1 position of the branched bitmap 250c. The histogram manager 170 then stores the third data element in one of the freed buckets in the root node 220 and increments the associated counter (Count-1). In all cases, the counters 240 at the root node 220 reflect both the counts of data elements stored directly in the root node 220 as well as counts of data elements accumulated in any child nodes.

In an example, the histogram manager 170 maintains counts of “special numbers” 204 using a header 202, which may be stored in connection with the tree 180. Special numbers do not have numerical precision. Examples of special numbers include positive 0, negative 0, positive infinity, negative infinity, and not-a-number (NaN), which indicates numbers that are undefined or unpresentable, such as 0/0. Common numerical standards, such as IEEE 754, represent special numbers with particular codes. The header 202 preferably includes a counter for each type of special number. Whenever the histogram manager 170 accesses a special number for filing, the histogram manager 170 increments the associated counter. Preferably, the tree 180 is not used to track special numbers directly.

Proceeding now to FIG. 3, multiple levels (Levels 2-5) of child nodes are shown. Each level organizes data elements based one a successive chunk 210. For example, child node 310 organizes data based on the second chunk 210b, providing a different bucket and a different counter for each unique value of the second chunk 210b. Likewise, child node 320 organizes data based on the third chunk 210c, providing a different bucket and a different counter for each unique value of the third chunk 210c. Also, child node 330 organizes data based on the fourth chunk 210d, providing a different bucket and a different counter for each unique value of the third chunk 210d, and child node 340 organizes data based on the fifth chunk 210d, providing a different counter for each unique value of the fifth chunk 210e.

In an example, each child node except the last child node 340 (leaf) includes a populated bitmap, a visited bitmap, and a branched bitmap, which are used the same way as the corresponding structures in the root node, described above. As no further branching may occur at the last child node 340, no branched bitmap is provided. No visited bitmap may be provided, either, as the 16 buckets included in the last child node 340 account for all possible values of data elements that can be placed therein. No buckets are required in child node 340, either, as values associated with the counts are implied.

Given the depicted arrangement, it is clear that child node 310 is provided for a single value of the first chunk 210a. This means that the value of the first chunk 210a is implied and that the buckets found in child node 310 need only store the values of chunks 210b through 210e. Similarly, child node 320 is provided for a single value of chunk 210a and a single value of chunk 210b, whose values are thus implied and need not be stored in the buckets of child node 320 (only values of chunks 210c through 210e are stored). Likewise, the buckets in child node 330 need only store values of chunks 210d and 210e, and the buckets in child node 340 need only store the values of chunk 210e. The arrangement typically allows child nodes to consume less memory space than their parents.

Although FIG. 3 shows only a single line of parent-child descendants, one should appreciate that each generation of child nodes may be more numerous than their respective parent nodes. In the illustrated arrangement, each parent node may have up to 16 child nodes. This represents a maximum, and typical numbers of child nodes may be much smaller than 16 due to concentrations of data elements in certain ranges. In an example, memory for supporting child nodes is allocated on demand, e.g., as child nodes are created in response to branches occurring in their respective parent nodes. This arrangement helps to maintain compactness in the tree 180.

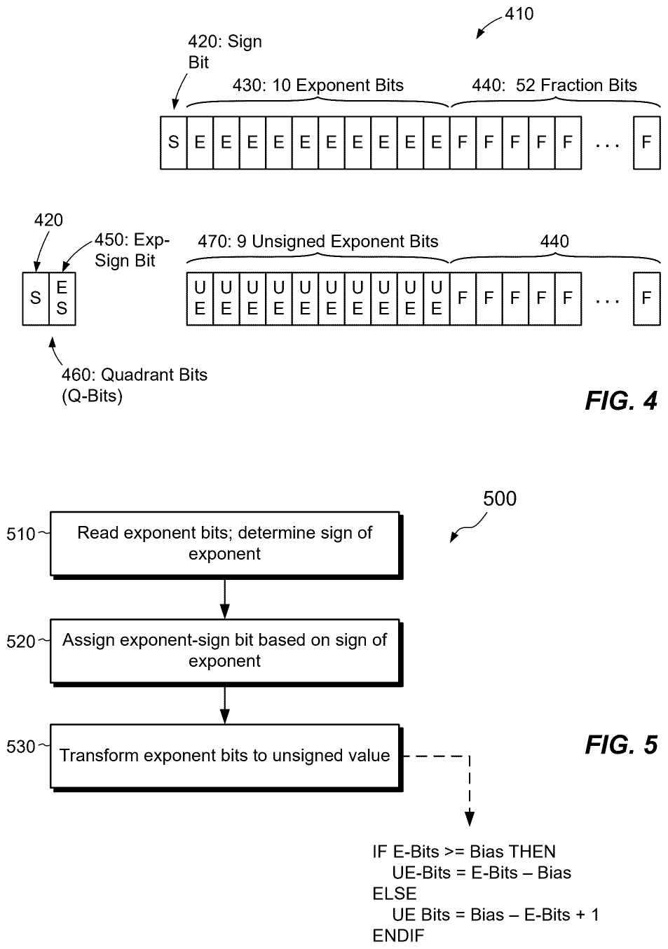

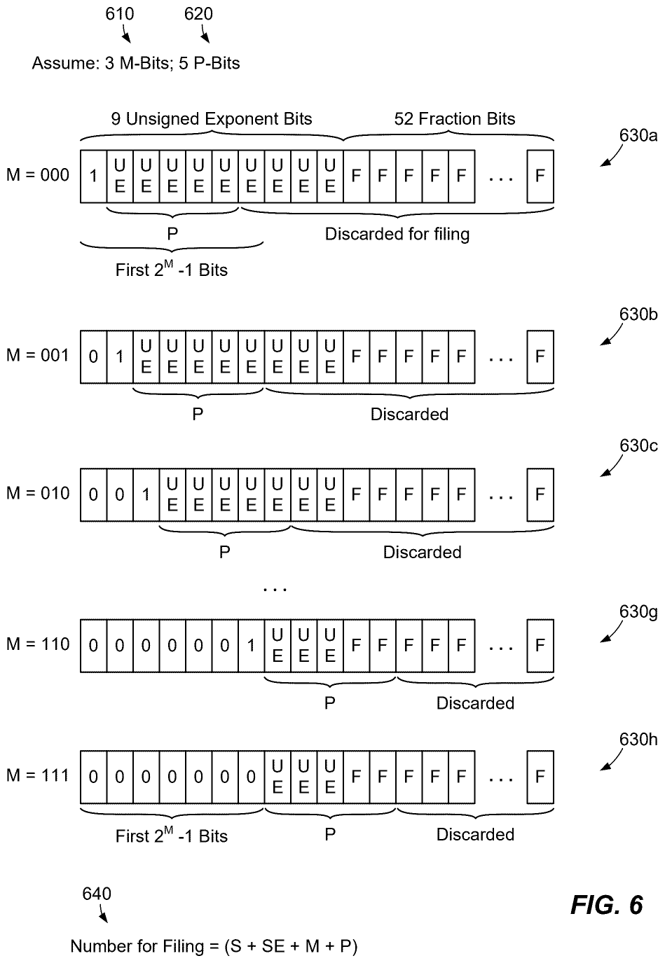

FIGS. 4-6 show an example methodology for expressing floating-point numbers in the above-described uniform binary format, which is suitable for numbers filed in the tree 180. FIGS. 4 and 5 show an example methodology for handling exponents, and FIG. 6 shows an example methodology for representing floating-point numbers using magnitude bits and precision bits.

Certain floating-point standards, such as IEEE 754, represent exponents of floating-point numbers using biasing. The biasing expresses all exponents (both positive and negative) as positive numbers. For example, exponents of 2 within the range between −1023 and +1023 (for double-precision) may be biased by 1023, such that the exponent bits provided in the floating-point numbers range from 0 to 2046. Although IEEE-754 floating-point numbers are shown here as an example, the disclosure is not limited to IEEE-754 floating-point numbers but rather may include other floating-point formats, such as BFloat16, IEEE Float32, IEEE Float16, and the like.

Starting with FIG. 4, an example format 410 of double-precision floating-point numbers is shown. The floating-point format 410 includes a sign bit 420 (S-Bit), 10 exponent bits 430 (E-Bits), and 52 fraction bits 440 (F-Bits). It is assumed that a leading binary “1” precedes the F-Bits (except in the case of denormalized numbers), but the leading 1 is not explicitly represented. Numerical values may be computed from the component bits as follows:

$$Numerical Value = {( - 1 )}^{S - Bit} * {2}^{( E - Bits - Bias )} * 1 \cdot ( F - Bits ) .$$

As shown at step 510 of FIG. 5, processing 500 of the E-Bits begins by reading the E-Bits 430 and determining a sign of the actual exponent being represented. For example, the histogram manager 170 may determine that the exponent-sign is negative based on the E-Bits 430 specifying a number less than 1022, or that the exponent-sign is positive based on the E-Bits specifying a number greater than 1023. The exponent-sign may be set arbitrarily to positive or negative for E-Bits specifying 1023 (0).

At 520, the histogram manager 170 assigns an exponent-sign bit 450 (ES-Bit) based on the determined sign of the exponent. For example, the ES-Bit 450 may be set to “0” for negative exponents and to “1” for positive exponents (The assignments are arbitrary and may be reversed, provided they are used consistently.)

In an example, the ES-Bit 450 may be grouped with the S-Bit 420 to provide a logical grouping referred to herein as “quadrant bits” (Q-Bits) 460. The Q-Bits specify 4 “quadrants” of numbers: positive sign, positive exponent; positive sign, negative exponent; negative sign, negative exponent; and negative sign, positive exponent and may facilitate certain data analysis and display tasks.

At 530, the E-Bits 430 from the original floating-point number may be transformed into unsigned exponent bits (UE-Bits). As shown at the bottom of FIG. 5, E-Bits greater than or equal to the bias are transformed into UE-bits by subtracting the bias from the E-Bits. Also, E-Bits less than the bias are transformed into UE-Bits by subtracting the E-Bits from the bias and adding 1.

Transforming the E-Bits 430 into the ES-Bit 450 and the UE-Bits 470 more clearly separates positive exponents from negative exponents and is better suited to chunk-based assignments of data elements to nodes 182. For example, providing UE-Bits 470 avoids situations in which numbers with different exponent signs are assigned to the same nodes 182 of the tree 180.

FIG. 6 shows example additional activities for expressing floating-point numbers in the uniform binary format. Here, it is assumed that exponents have already been modified as shown in FIGS. 4 and 5. The FIG. 6 activities involve determining a set of magnitude bits (M-Bits) 610 and a set of precision bits (P-Bits) 620 for each floating-point number to be filed. In some examples, the number of M-Bits 610 and the number of P-Bits 620 are configurable parameters. The illustrated example assumes 3 M-Bits and 5 P-Bits.

In an example, the histogram manager 170 determines the M-Bits for a number based on the bit location of the first (most-significant) “1” to occur within the first 2^{M}−1 bits of the number, excluding the Q-Bits 460. Thus, for M=3 (as shown), the histogram manager 170 scans for the first 1 within the first 2³−1=7 bits of the number. The P-Bits are then the P=5 bits that immediately follow the first 1. For example, number 630a has a first 1 in the 0^{th} bit position (counting starts from 0), corresponding to M-Bits of 000. The P-Bits are then assigned as the next 5 bits. Any bits that follow the P-Bits may simply be discarded, as they are not used for filing. If greater precision is desired, the number of P-Bits can be increased.

Proceeding to number 630b, the first 1 appears in the 1^{st} bit position, corresponding to M-Bits of 001, with the P-Bits being the next 5 bits. Similarly, number 630c has a first 1 in the 2^{nd} bit position, yielding M-Bits of 010, with the 5 P-Bits immediately following. The pattern continues through number 630g, where the first 1 appears in the 6^{th} bit position, yielding M-Bits of 110. The 5 P-Bits immediately follow.

For number 630h, however, no first 1 exists within the first 2^{M}−1 bits of the number. The number 630h is thus deemed to be off-scale and cannot be represented completely. To indicate this off-scale condition, the M-bits are assigned a value of 111 (all 1's, or 2^{M}−1), and the P-Bits are taken as the 5 bits beginning at the (2^{M})-th bit position, i.e., the position that immediately follows the (2^{M}−1)-bit range. It is noted that the P-Bits for number 630h are in the same bit locations as the P-Bits for number 630g. If it is desired to accurately represent off-scale numbers, the number of M-Bits can be increased.

Once the M-Bits 610 and the P-Bits 620 for a number have been determined, the number can be expressed in the uniform binary format as a result 640 of concatenating the Q-Bits 460 (i.e., sign bit 460 and exponent-sign bit 450) with the M-Bits 610 and the P-Bits 620. In the illustrated example, the total size of the result 640 is 10 bits, but using 5 M-Bits and 13 P-Bits would yield a 20-bit result, consistent with the example shown in FIGS. 2 and 3.

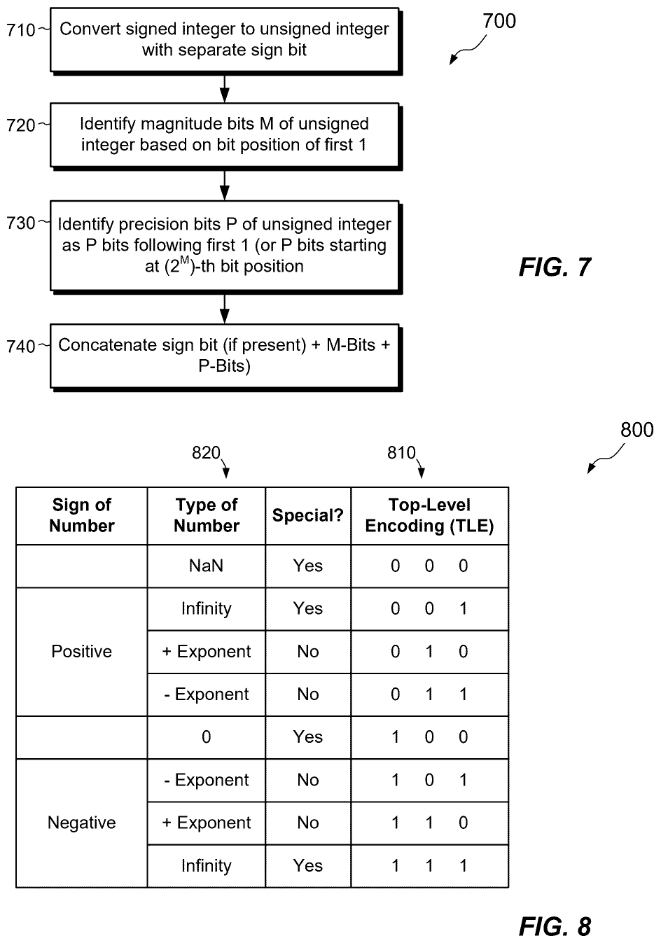

FIG. 7 shows an example method 700 of representing integers in the uniform binary format. A simple way of handling integers is to convert them to floating-point numbers and then to express the resulting floating-point numbers in the uniform binary format, as described above. The converted floating-point number could be in a non-standard format, as an exponent-sign bit is not needed for integers and fewer bits are required for the exponent field. If filing integer numbers natively, without conversion to a floating-point format, larger numbers of M-Bits and smaller numbers of P-Bits could be employed than are used with floating-point numbers.

Method 700 provides an alternative to the above approach. At 710, the histogram manager 170 receives a signed integer and converts the signed integer to an unsigned integer and a separate sign bit. M-Bits and P-Bits are then determined using similar processing to that shown in FIG. 6.

At 720, M-Bits are determined by identifying the bit position of the first (most-significant) “1” within the first (2^{M}−1) bits of the unsigned integer. If no 1 is found within the first (2^{M}−1) bits, the M-Bits are assigned a value of 2^{M}−1. At 730, the P-Bits are assigned as the P bits that immediately follow the first 1, or they are assigned as the P bits that begin at the (2^{M})-th bit position if no 1 is found within the first (2^{M}−1) bits. At 740, an overall result in the uniform binary format is determined as the concatenation of the sign bit with the M-Bits and the P-Bits. The sign bit may be omitted if only positive (or negative) integers are considered.

FIG. 8 shows an example table 800 of top-level encodings (TLEs) 810, which may be used in certain embodiments. TLEs 810 provide an alternative to quadrant bits 640, and they also serve to identify special numbers. TLEs are particularly useful for arranging multidimensional data in histogram trees.

As shown, TLE's 810 may be provided as 3-digit binary numbers, which may be assigned arbitrarily to respective types 820 of numbers. For example, a value of 000 may be assigned (arbitrarily) to NaN, a value 001 may be assigned to positive infinity, a value of 010 may be assigned to positive numbers with positive exponents, and so on, as indicated in the table 800. TLEs are provided both for special numbers (NaN, positive infinity, 0, and negative infinity) and for non-special numbers (positive sign, positive exponent; positive sign, negative exponent; negative sign, negative exponent; and negative sign, positive exponent). Only a single value of 0 is supported with this encoding, but this is merely a design choice.

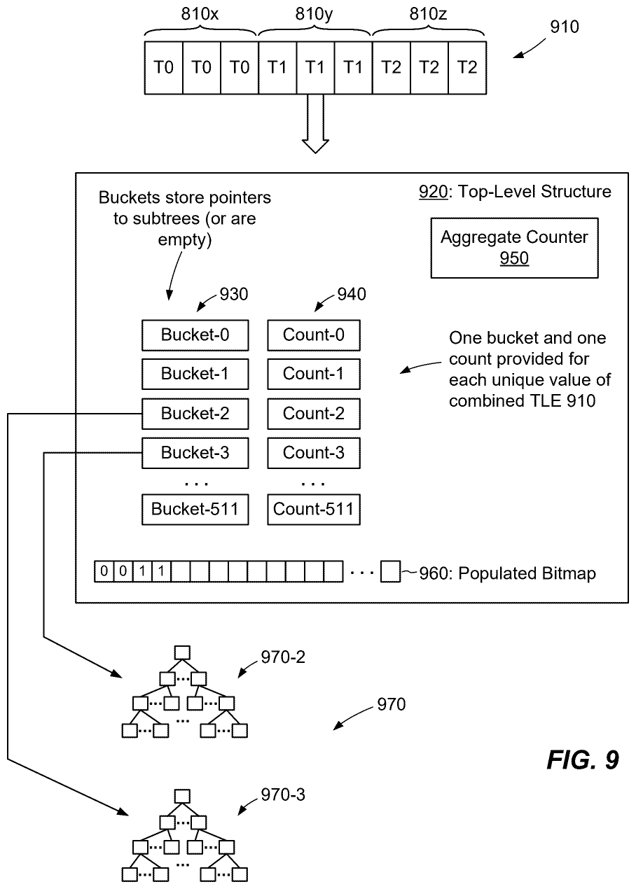

FIG. 9 shows an example arrangement for filing multidimensional data. The illustrated example involves 3-dimensional data, but a similar approach may be used for data having any number of dimensions, including a single dimension.

A top-level structure 920 is provided for arranging different combinations of number types for different dimensions. For example, x, y, and z dimensions of 3-D data elements may contain respective types of numbers having respective TLEs 810. As there are 8 possible TLEs for each dimension, there is a total of 8-cubed=512 possible TLE combinations across all three dimensions. The top-level structure 920 preferably tracks each combination individually.

For example, TLEs 810x, 810y, and 810z for numbers in the respective x, y, and z dimensions of a data element are concatenated in order to form a combined TLE 910. The TLEs may be concatenated in any order (e.g., x-y-z, y-z-x, etc.) as long as the same ordering is used consistently. The top-level structure 920 provides a respective bucket 930 and a respective counter 940 for each of the 512 possible values of combined TLE (counters 940 are optional in some embodiments). The top-level structure 920 may also maintain an aggregate counter 950 (also optional) and a populated bitmap 960, which has 512 elements. For simplicity, no branching is supported in the top-level structure 920, which is implemented as a single level. A multi-level (tree) structure may be used if desired, however. The top-level structure 920 does not support visited buckets, as each bucket 930 and its associated counter 940 are dedicated to a respective combined TLE 910.

Each of the buckets 930 may be empty or populated. Given the dedicated assignment of buckets 930 to combined TLEs, there is no need to store combined TLEs 910 within the buckets 930, as the buckets themselves serve as identifiers of the combined TLEs. Instead, the buckets 930 (if populated) store pointers to subtrees 970. As shown, Bucket-2 points to subtree 970-2 and Bucket-3 points to subtree 970-3. In an example, each of the subtrees 970 has the same basic design as the tree 180 shown in FIGS. 2 and 3 and is operated the same way. For example, each subtree 970 stores data elements for a respective combined TLE 910 in nodes 182 based on chunks 210 of the data elements to be filed.

Subtrees 970 are provided for storing data elements that have at least one non-special dimension. Data elements consisting of only special dimensions have no subtrees, as the combined TLEs 910 of those data elements are sufficient to describe them fully.

In example operation, the histogram manager 170 accesses a 3-D data element for filing. The histogram manager 170 generates a TLE for each dimension of the 3-D data element and concatenates the TLEs into a combined TLE 910. The histogram manager 170 then increments the counter 940 associated with that combined TLE 910 and increments the aggregate counter 950. The histogram manager 170 also sets the bit corresponding to the combined TLE in the bitmap 960, if the bit has not already been set.

The histogram manager 170 then checks whether the combined TLE indicates all special dimensions. If yes, then filing is complete and no further action is needed. But if the combined TLE indicates at least one non-special dimension, the histogram manager 170 files the 3-D data element in a subtree provided for that combined TLE (e.g., the subtree pointed to by the bucket 930 assigned to that combined TLE, creating the subtree if this is the first instance). Filing is then complete. Filing of the 3-D data element is performed in the same manner as described above (FIGS. 2 and 3).

The above operation can be repeated for any number of 3-D data elements. Counts are accumulated and subtrees are populated.

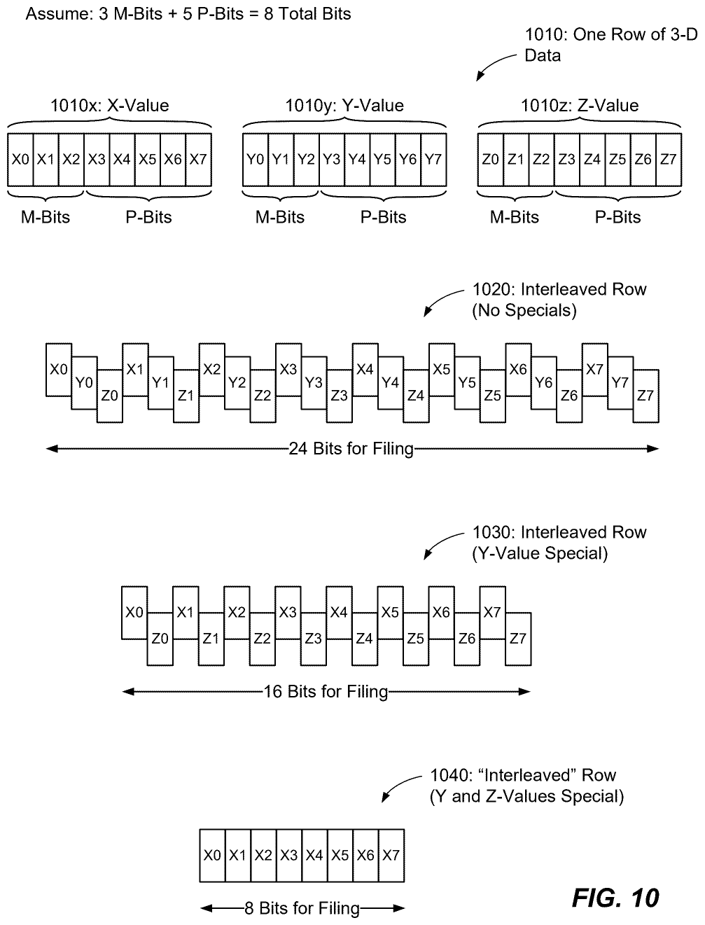

FIG. 10 shows an example arrangement for representing multidimensional data elements, such as those which are filed in the manner described in connection with FIG. 9. The depicted example assumes 3-D data elements, but the example can be generalized to any number of dimensions.

As shown, a row 1010 of 3-D data includes an x-value 1010x, a y-value 1010y, and a z-value 1010z. Each of the x, y, and z values is 8-bits long and includes 3 M-Bits and 5 P-Bits. These are merely examples.

Combining the x, y, and z values into data elements having the uniform binary format may involve interleaving bits of the x-value 1010y with bits of the y-value 1010y and bits of the z-value 1010z. Interleaving may be performed in any desired manner, but interleaving on the individual bit level has been found to be both convenient and efficient. For example, an interleaved row 1020 is constructed by taking one bit of X, one bit of Y, and one bit of Z, and then returning to X and repeating until all bits have been taken.

Dimensions containing special numbers need not be included when preparing data elements for filing, as any dimensions with special numbers are fully described by the associated combined TLEs 910. The interleaved row 1020 assumes that there are no special dimensions. Thus, the x-value 1010y, y-value 1010y, and z-value 1010z are all non-special and the data element formed by interleaving is 24 bits long. Accordingly, the subtree 970 used for filing this data element works with 24-bit data, e.g., six 4-bit chunks 210.

Interleaved row 1030 has a single special dimension, in this case the Y dimension. Thus, bits from the y-value 1010y are excluded from the interleaved row, and the resulting data element is 16 rather than 24 bits long. Accordingly, the subtree 970 used for filing the data element 1030 works with 16-bit data, e.g., four 4-bit chunks 210.

Interleaved row 1040 has two special dimensions, in this case the Y and Z dimensions. Thus, bits from the y-value 1010y and bits from the z-value 1010-z are excluded from the interleaved row, and the resulting data element is 8 bits long. Accordingly, the subtree 970 used for filing data element 1040 works with 8-bit data, e.g., two 4-bit chunks 210.

No representations are needed for filing data containing all special dimensions. Rather, the combined TLEs 910 alone are sufficient to fully describe them.

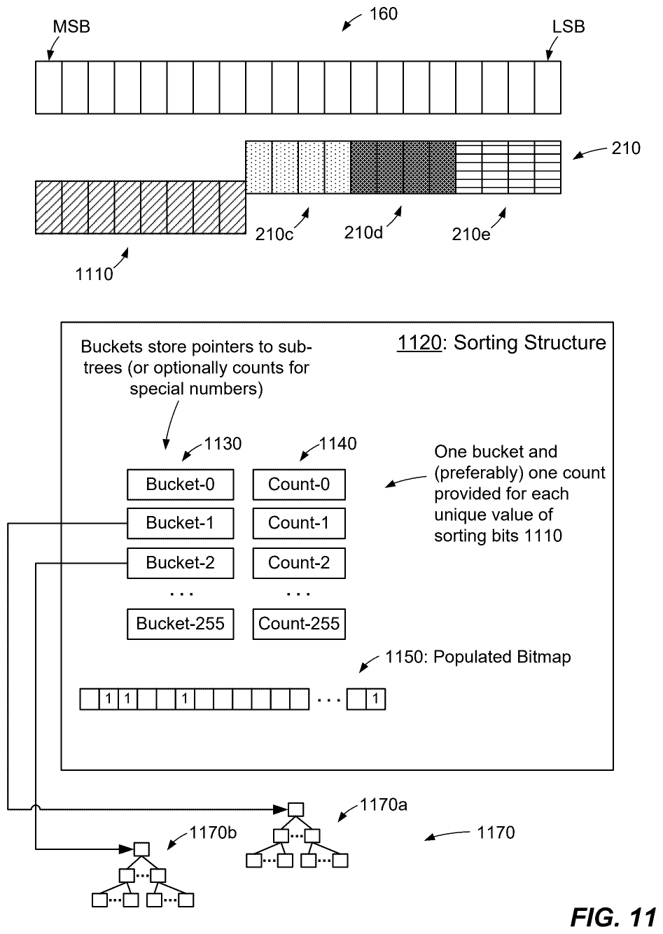

FIG. 11 shows an example adjunct to the histogram tree 180 presented in FIGS. 2 and 3. We have observed that many histograms have dense concentrations of data elements 160 in a few regions but are otherwise sparse. In such examples, histograms can be implemented efficiently by providing a sorting structure 1120, above the root level 220 of FIG. 2, which can fan out to multiple sub-trees 1170 each resembling the tree 180 shown in FIGS. 2 and 3. Sub-trees 1170 are not needed for regions where no data elements 160 are found and can thus be omitted.

As shown in FIG. 11, a sorting value 1110 may be designated as some number of most-significant bits of the data elements 160 to be filed, such as 8 bits in the example shown (other examples include 6 bits, 10 bits, etc.). The remaining bits of the data elements 160 are rendered as multiple chunks 210, such as the chunks 210c, 210d, and 210e. The sorting structure 1120 is configured to sort data elements 160 based on sorting value 1110. If the sorting value is N bits long, the sorting structure 1120 includes 2^{N} buckets 230, one for each unique sorting value 1110 (e.g., 256 buckets for N=8). Preferably, each bucket 1130 has an associated counter 1140, which tracks the number of data elements 160 filed in the respective bucket. Counters 1140 may be provided as a convenient optimization but are not strictly required, as counts may instead be obtained by scanning the sub-trees 1170. In some examples, the sorting structure 1120 further includes a “populated” bitmap 1150, which contains 2^{N} (e.g., 256 for N=8) bit positions, one for each unique sorting value 1110, and thus one for each bucket 1130. Each bit position in the bitmap 1150 indicates whether any data elements 160 with the associated sorting value 1110 have been filed. The sorting structure 1120 has no need for a “visited” bitmap, as buckets 1130 are dedicated to respective sorting values 1110.

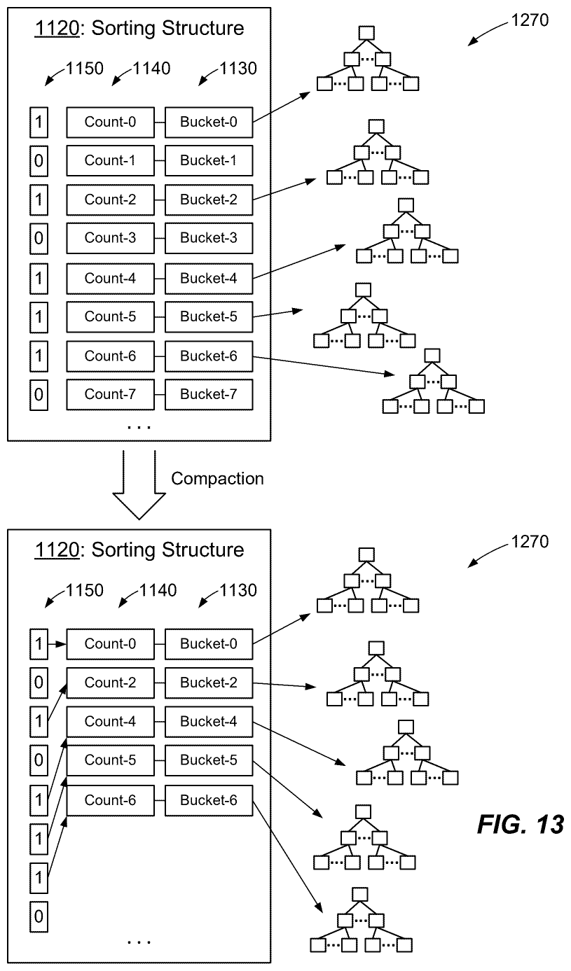

In some examples, the populated bitmap 1150 may be omitted from the sorting structure 1120, as counts 940 may indicate just as well whether a bucket 930 is populated. If initially omitted, a populated bitmap 1150 may be added later to support data compaction, as described in connection with FIG. 13 below.

In an example, buckets 1130 corresponding to bits that are set in the bitmap 1150 store pointers (offsets) to respective sub-trees 1170, such as sub-trees 1170a and 1170b, which are dedicated to respective sorting values 1110. Accordingly, all data elements 160 filed in any one sub-tree 1170 have the same top N bits. Buckets 1130 corresponding to bits that are unset in the bitmap 1150 may be empty, and no sub-trees 1170 for these buckets need be provided. In some examples, a bucket 1130 stores a pointer to a sub-tree 1170 only for associated counts 1140 greater than 1. If a bucket 1130 is associated with a count 1140 that equals 1, the bucket may instead store the data element itself (e.g., without the sorting value 1110, which is implied). It is noted that no “branched” bitmap is needed in the sorting structure 1120, as every bit that is set in the populated bitmap 1150 already indicates a branch to a respective sub-tree 1170.

Each of the sub-trees 1170 pointed to by buckets 1130 may resemble the tree 180 shown in FIGS. 2 and 3 and may be referred to herein as a “tree,” the primary difference being that a sub-tree 1170 sorts only the portion of data elements 160 appearing after the sorting value 1110, e.g., the portion containing chunks 210c, 210d, and 210e. The sub-trees 1170 may sort these chunks as described above, although fewer levels of child nodes will be needed for the same-size data elements 160, corresponding to the fewer number of chunks 210.

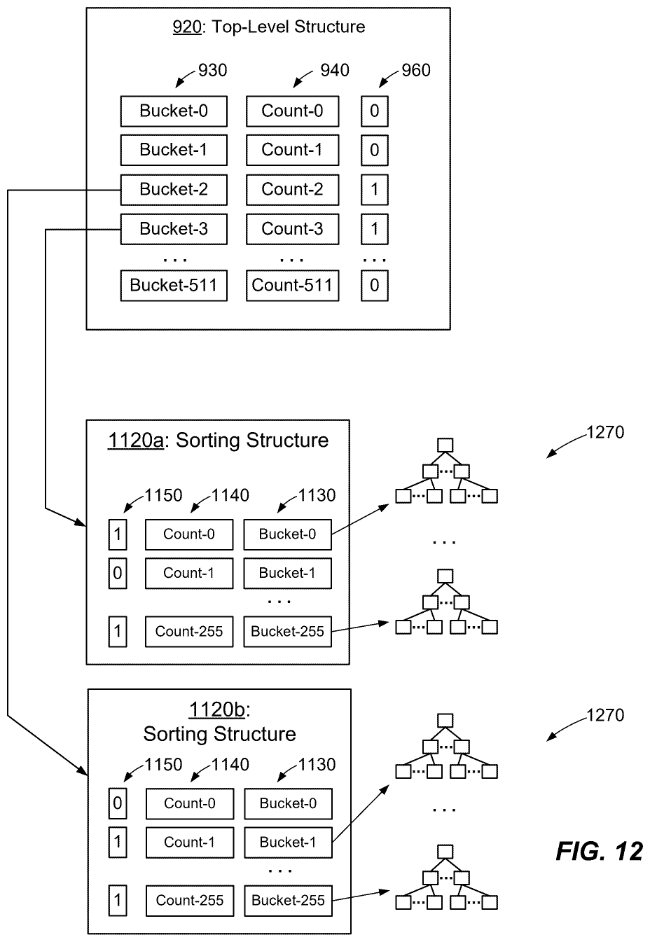

FIG. 12 shows an example arrangement of using sorting structures 1120 for filing multidimensional data elements, such as described in connection with FIGS. 9 and 10. Rather than having the buckets 930 point directly to root nodes 220 of sub-trees 970, as in FIG. 9, the buckets 930 here may instead point to respective sorting structures 1120 (1120a and 1120b), which in turn fan out to multiple sub-trees 1270. Each of the sub-trees 1270 resembles the tree 180 shown in FIGS. 2 and 3 and may be referred to herein either as a “sub-tree” or a “tree.” In the figure, the bitmaps 960 and 1150 are aligned vertically to show the correspondence of bit positions of the bitmaps to associated buckets and counts.

FIG. 13 shows an example arrangement for compacting trees 180, top-level structures 920, and sorting structures 1120. Compacting of these structures is possible because buckets and counters are only relevant if they correspond to bits that are set in an associated “populated” bitmap (250a, 960, or 1150). Bucket and counters that are not associated with set bits in such a bitmap can be removed. The example in FIG. 13 applies to sorting structures 1120, but the same approach can be used with top-level structures 920 and trees 180.

Starting at the top of FIG. 13, the populated bitmap 1150 has bits set for positions 0, 2, 4, 5, and 6 (bit positions beyond the 7^{th} position are not shown). For each of these set bit positions, there is an associated bucket 1130 and counter 1140, and the associated bucket 1130 points to a respective sub-tree 1270 in which one or more data elements 160 are filed. Buckets and counters for unset bit positions in the bitmap 1150 (e.g., positions 1, 3, and 7) are unused, and such buckets do not point to sub-trees 1270. Accordingly, such buckets and counters may be removed.

An example result of compaction is shown at the bottom of FIG. 13. Here, all of the buckets 1130 and counts 1140 corresponding to unset bit positions in the bitmap 1150 have been removed, such that the remaining buckets and counts are only those for which the bit positions in the bitmap 1150 are set. Also, the remaining buckets and counts are placed adjacently, without no gaps remaining between them.

Any i^{th} bucket or counter can be found in the compacted results by identifying the ordinal position of the set bit in the i^{th} position among the other set bits in the bitmap 1150. For example, the bucket and counter for the sixth bit position can be found by noting that the sixth bit position in the bitmap 1150 contains the fifth “1” (counting up from the zeroth position). The bucket and counter for the sixth bit position is then determined as the fifth bucket-counter pair in the compacted results. Similar compaction can be performed for counters and buckets in the examples of FIGS. 2, 3, and 9, with counters and buckets removed and compacted away when the corresponding bit locations in the associated populated bitmaps are unset.

Similar compaction may be carried out with visited and branched bitmaps 250b and 250c (FIGS. 2 and 3). For example, bits in the visited and branched bitmaps 250b and 250c are only relevant for bits that are set in the populated bitmap 250a. Thus, bit positions corresponding to unset bits in the bitmap 250a may be removed from the bitmaps 250b and 250c, and the remaining bits in the respective bitmaps may be compacted. To determine whether an it bucket is visited or branched, the histogram manager 170 determines the ordinal position of the set bit in the corresponding it position of the populated bitmap 250a from among the other set bits in the populated bitmap 250a. The ordinal position directly implies the corresponding bit position in the compacted bitmap, visited or branched.

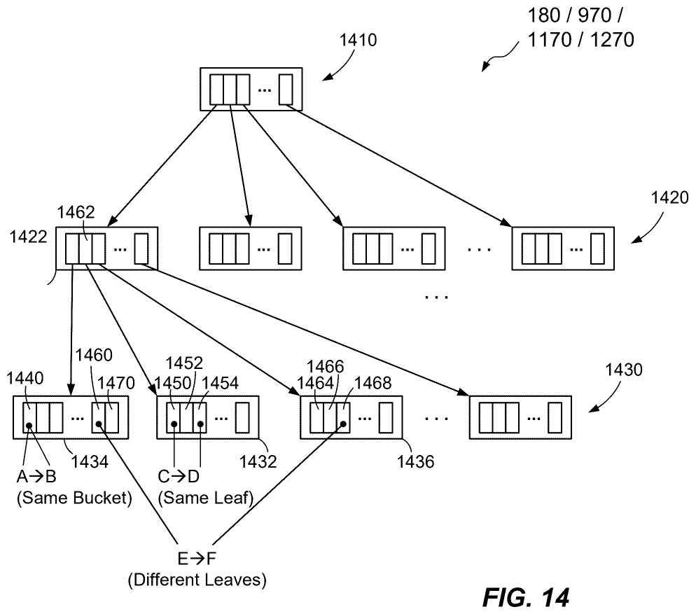

FIG. 14 shows an example arrangement for querying a histogram tree 180, according to any of the embodiments described above. The depicted arrangement also applies to querying any structures that include sub-trees 970, 1170, or 1270. In this example, the tree (or subtree) has three levels, a root level 1410, a middle level 1420, and leaf (second child) level 1430. This is merely for illustration, as the tree/sub-tree may include any number of levels.

A first querying scenario presents a simple case. Here, the query and display manager 190 submits a query that requests an inclusive count of all data elements 160 between two values, A and B. If both A and B fall within a single logical bucket 1440 of a leaf node 1430, then the requested count is just the value of the counter associated with that logical bucket 1440, i.e., the value stored in the corresponding counter 240 (FIG. 3). The term “logical bucket” refers to each unique value of the last chunk 210 of data elements that are sorted by a leaf. The term is used because leaf nodes have counters 240 but do not require actual, physical buckets 230.

As another example, consider a query that requests a total inclusive count of data elements between values C and D. Here, logical buckets for data elements having values C and D are both found within the same leaf 1432, but within different (logical) buckets 1450 and 1454 of that leaf 1432. A single intervening bucket 1452 appears between buckets 1450 and 1454. Multiple intervening buckets may be found in other examples. To determine the requested count, the query and display manager 190 obtains the values of counters 240 associated with buckets 1450, 1452, and 1454 and sums the counter values together, thus providing the requested total count. If the requested count had been exclusive rather than inclusive, then only the counter value associated with bucket 1452 would have been returned.

As yet another example, consider a query that requests a total inclusive count of all data elements between values E and F. Here, logical buckets for values E and F are found in different leaf nodes, 1434 and 1436, respectively, with a leaf node 1432 being intervening. Responding to the query in this example leverages the fact that counters 240 found in parent nodes aggregate the counts of their respective child nodes, so that it is not necessary to visit and scan each and every leaf node involved in a query range to obtain a total. Here, for example, the query and display manager 190 starts with the count associated with bucket 1460 and proceeds to add counts of individual buckets (1470), until it reaches the end of the current leaf node 1434. The query and display manager 190 then proceeds to the next leaf 1432. Although the counts associated with leaf 1432 must be included in the query results, it is not necessary to visit the leaf node 1432 (or other intervening leaf nodes, if there are any) to obtain the counts. Rather, query and display manager 190 accesses the aggregate counter associated with bucket 1462 in node 1422 and adds the aggregate counter value to the running total. The node 1422 may be referred to herein as a “lowest common node,” i.e., the lowest-node in the tree/sub-tree that includes the entire requested query range. The query and display manager 190 then proceeds to the next leaf 1436, which contains a bucket for data element F, and adds the counts associated with individual buckets 1464, 1466, and 1468. The total count is then returned in response to the query. This example illustrates the fact that responding to queries spanning multiple leaf nodes 1430 involves little or no additional computing resources as compared with responding the queries that involve only a single leaf node. It is noted that counts for buckets 1460 and 1468 would be omitted from the reported total if the query had been exclusive.

One can see that examples can be extended to even more separated data elements, such that the root level 1410 becomes the lowest common node, i.e., for queries that extend across multiple middle-level nodes 1420. The higher the lowest common node is for any query, the greater the computational saving that can be realized by providing aggregate counts.

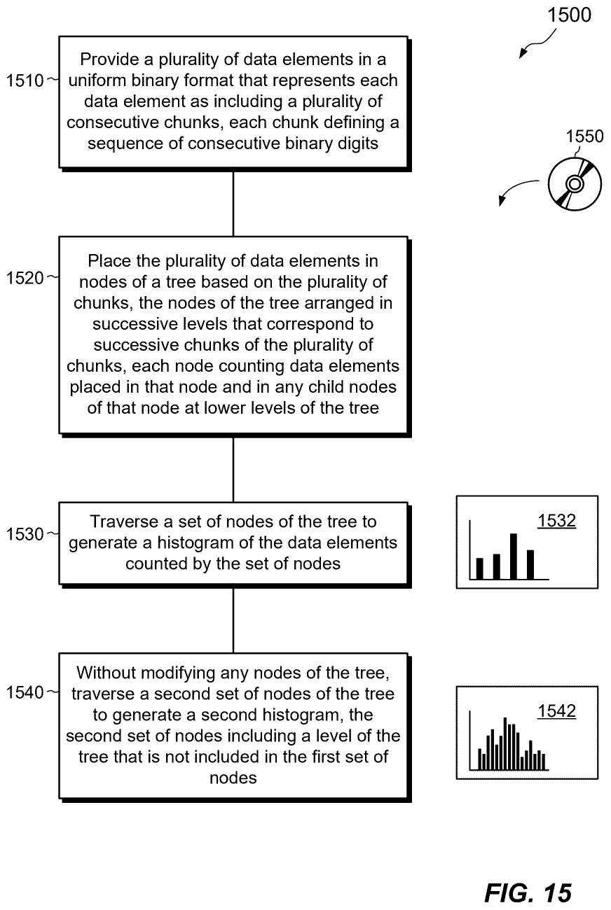

FIG. 15 shows an example method 1500 that may be carried out in connection with the computing device 100 and provides an overview of some of the features described above. The method 1500 is typically performed, for example, by the software constructs described in connection with FIG. 1, which reside in the memory 130 of the computing device 100 and are run by the set of processors 120. The various acts of method 1500 may be ordered in any suitable way. Accordingly, embodiments may be constructed in which acts are performed in orders different from that illustrated, which may include performing some acts simultaneously.

At 1510, a plurality of data elements 160 is provided in a uniform binary format that represents each data element as a plurality of consecutive chunks 210, each chunk 210 defining a sequence of consecutive binary digits, such as four digits as shown in FIGS. 2 and 3.

At 1520, the plurality of data elements 170 is placed in nodes 182 of a tree 180 based on the plurality of chunks 210. The nodes 182 of the tree 180 (e.g., nodes 220, 310, 320, 330, and 340) are arranged in successive levels (e.g., Level 1 through Level 5) that correspond to successive chunks (e.g., chunks 210a through 210e) of the plurality of chunks. Each node 182 counts data elements 160 placed in that node and in any child nodes (e.g., nodes 310, 320, 330, and/or 340) of that node at lower levels of the tree 180.

At 1530, a set of nodes of the tree is traversed to generate a histogram 1332 of the data elements 160 counted by the set of nodes 182. The set of nodes may be limited to certain levels of the tree, such as to only the root node 220, or the root node 220 and the second-level nodes (at the same level as child node 310). Alternatively, the set of nodes may include all nodes 182 of the tree 180.

At 1540, without modifying any nodes 182 of the tree 180, a second set of nodes of the tree is traversed to generate a second histogram 1542, the second set of nodes including a level of the tree that is not included in the first set of nodes. For example, the first set of nodes may include only the root node 220, and the second set of nodes may include the root node and the second-level nodes.

In some examples, the method 1500 may be embodied as a computer program product including one or more non-transient, computer-readable storage media 1550, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like. Any number of computer-readable media may be used. The media may be encoded with instructions which, when executed on one or more computers or other processors, perform the process or processes described herein. Such media may be considered articles of manufacture or machines, and may be transportable from one machine to another.

An improved technique has been described for generating histograms. The technique includes providing data elements 160 in a uniform binary format as multiple consecutive chunks 210, where each chunk 210 includes a sequence of consecutive binary digits. The technique includes placing the data elements 160 in nodes 182 of a tree 180 based on the chunks 210. The nodes 182 are arranged in successive levels (e.g., nodes 310, 320, 330, and/or 340) that correspond to successive chunks (e.g., chunks 210a through 210e). Each node 182 counts the data elements placed in that node and in any child node of that node at lower levels of the tree. The technique further includes traversing one or more nodes 182 of the tree 180 to generate a histogram 1532 of the data elements counted by that node or nodes.

Having described certain embodiments, numerous alternative embodiments or variations can be made. For example, although a single computing device 100 has been shown for performing operations described herein, this is merely an example, as such operations may be performed by any number of computers operating together. Also, the computing device 100 (or devices) may operate in a client-server arrangement whereby clients submit datasets, e.g., over a network such as the Internet, and the computing device or devices generate histograms as a service to such clients.

Further, although features have been shown and described with reference to particular embodiments hereof, such features may be included and hereby are included in any of the disclosed embodiments and their variants. Thus, it is understood that features disclosed in connection with any embodiment are included in any other embodiment.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Further, although the term “user” as used herein may refer to a human being, the term is also intended to cover non-human entities, such as robots, bots, and other computer-implemented programs and technologies. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A computerized method of generating histograms, comprising:
providing a plurality of data elements in a uniform binary format that represents each data element as including a plurality of consecutive chunks, each chunk defining a sequence of consecutive binary digits;
placing the plurality of data elements in nodes of a tree based on the plurality of chunks, the nodes of the tree arranged in successive levels that correspond to successive chunks of the plurality of chunks, each node counting data elements placed in that node and in any child nodes of that node at lower levels of the tree; and
traversing a set of nodes of the tree to generate a histogram of the data elements counted by the set of nodes.

2. The method of claim 1, wherein the set of nodes is a first set of nodes, and wherein the method further comprises, without modifying any nodes of the tree, traversing a second set of nodes of the tree to generate a second histogram, the second set of nodes including a level of the tree that is not included in the first set of nodes.

3. The method of claim 1, wherein a most-significant chunk of the plurality of chunks includes N bits that specify 2^{N} binary values, and wherein placing the plurality of data elements includes:
providing a root node of the tree that includes 2^{N} buckets and 2^{N} counters, one bucket and one counter for each of the 2^{N} binary values;
storing a first data element of the plurality of data elements in a first bucket of the 2^{N} buckets, the first bucket selected based on a most-significant N bits of the first data element; and
incrementing the counter provided for the first bucket.

4. The method of claim 3, wherein the root node further includes a first tracking structure having 2^{N} elements, one element for each of the 2^{N} binary values, and wherein placing the plurality of data elements further includes marking the first bucket as populated in the first tracking structure.

5. The method of claim 3, wherein placing the plurality of data elements further includes:
determining that an additional data element of the plurality of data elements matches the first data element; and
in response to the determination, incrementing the counter provided for the first bucket.

6. The method of claim 3, wherein placing the plurality of data elements further includes:
storing a second data element of the plurality of data elements in a second bucket of the 2^{N} buckets different from the first bucket, based on (i) a most-significant N bits of the second data element matching the most-significant N bits of the first data element and (ii) the second data element differing from the first data element at other bit locations; and
incrementing the counter associated with the second bucket.

7. The method of claim 6, wherein the root node further includes a second tracking structure having 2^{N} elements, one for each of the 2^{N} binary values, and wherein placing the plurality of data elements further includes marking the second bucket as visited in the second tracking structure, the visited marking indicating that the second bucket was not provided for the most-significant N bits of the second data element.

8. The method of claim 3, wherein the root node is disposed at a first level of the tree, and wherein placing the plurality of data elements further includes:
storing a third data element of the plurality of data elements in a child node of the root node disposed at a second level of the tree;
storing a pointer to the child node in a third bucket of the 2^{N} buckets;
incrementing the counter associated with the third bucket; and
incrementing a counter associated with the child node,
wherein the child node is configured to store or point to data elements of the plurality of data elements whose most-significant N bits are all the same.

9. The method of claim 8, wherein the root node further includes a third tracking structure having 2^{N} elements, one for each of the 2^{N} binary values, and wherein placing the plurality of data elements further includes marking the third bucket as branched in the third tracking structure, the branched marking indicating that the third bucket stores the pointer to the child node.

10. The method of claim 3, wherein providing the plurality of data elements includes:
receiving a plurality of floating-point numbers, each floating-point number including a sign bit, multiple exponent bits, and multiple fraction bits; and
converting the plurality of floating-point numbers into at least some of the plurality of data elements having the uniform binary format, said converting including, for each of the plurality of floating-point numbers, providing an exponent-sign bit that represents a sign of an exponent of the floating-point number, and modifying the exponent bits to represent the exponent as an unsigned value.

11. The method of claim 10, wherein modifying the exponent bits includes subtracting a bias from the exponent of each floating-point number having a positive exponent.

12. The method of claim 11, wherein modifying the exponent bits further includes subtracting the exponent from the bias and adding 1 for each floating-point number having a negative exponent.

13. The method of claim 10, wherein converting the plurality of floating-point numbers further includes grouping together the modified exponent bits with the fraction bits of each floating-point number and transforming the grouped bits into a shortened sequence that includes an M-bit magnitude value and a P-bit precision value.

14. The method of claim 13, wherein transforming the grouped bits includes, for a first floating-point number of the plurality of floating-point numbers:
identifying a bit position of a most-significant 1 that appears within a most-significant 2^{M}−1 bits of the grouped bits;
converting the bit position of the most-significant 1 to the M-bit magnitude value that represents the bit position of the most-significant 1;
identifying the P-bit precision value as a P-bit sequence in the grouped bits that immediately follows the bit position of the most-significant 1; and
concatenating the M-bit magnitude value with the P-bit precision value.

15. The method of claim 13, wherein transforming the grouped bits includes, for a second floating-point number of the plurality of floating-point numbers:
determining that none of a most-significant 2^{M}−1 bits of the grouped bits is a 1;
in response to said determining, assigning the M-bit magnitude value to all 1's;
identifying the P-bit precision value as a P-bit sequence that begins at the (2^{M})-th bit position of the grouped bits; and
concatenating the M-bit magnitude value with the P-bit precision value.

16. The method of claim 13, wherein converting the plurality of floating-point numbers into said at least some of the plurality of data elements having the uniform binary format further includes concatenating together the sign bit, the exponent-sign bit, the M-bit magnitude value, and the P-bit precision value.

17. The method of claim 13, further comprising storing a header with the tree, the header indicating a respective count of each of the following special number types: positive infinity; negative infinity, at least one type for zero, and not a number (NaN).

18. The method of claim 3, wherein providing the plurality of data elements includes:
receiving a plurality of integer numbers; and
converting the plurality of integer numbers into at least some of the plurality of data elements having the uniform binary format, said converting including, for each integer number of the plurality of integer numbers:
generating an M-bit magnitude value as one of (i) a bit position of a most-significant 1 within a most-significant (2^{M}−1) bits of the integer number, responsive to the most-significant 1 existing or (ii) all 1's responsive to the most-significant 1 not existing;
generating a P-bit precision value as one of (i) a P-bit sequence that immediately follows the most-significant 1, responsive to the most-significant 1 existing or (ii) a P-bit sequence beginning at the (2^{M})-th bit position of the integer number responsive to the most-significant 1 not existing; and
concatenating the M-bit magnitude value with the P-bit precision value.

19. The method of claim 3, wherein providing the plurality of data elements includes:
receiving a plurality of floating-point numbers;
receiving a plurality of integer numbers;
converting the plurality of floating-point numbers into a first subset of the plurality of data elements having the uniform binary format;
converting the plurality of integer numbers into a second subset of the plurality of data elements having the uniform binary format.

20. The method of claim 19, wherein converting the plurality of integer numbers into the second subset of the plurality of data elements includes:
transforming the plurality of integer numbers into a second plurality of floating-point numbers; and
transforming the second plurality of floating-point numbers into the uniform binary format.

21. The method of claim 3, wherein the tree is a first subtree of multiple subtrees, wherein the plurality of data elements is part of a multiplicity of data elements, wherein the data elements represent multidimensional data in which a number is provided for each dimension of each data element, and wherein the method further comprises:
assigning a top-level encoding (TLE) to the number provided for each dimension of each data element of the multiplicity of data elements, the TLE being a binary value that identifies a type of the number from among multiple types of numbers;
generating a combined TLE for each data element by concatenating the TLE assigned to the number provided for each dimension with the TLE assigned to the number provided for each other dimension of that data element;
assigning data elements to buckets of a top-level structure based on combined TLEs, such that each bucket of the top-level structure is provided for a respective value of combined TLEs; and
counting data elements assigned to each bucket.

22. The method of claim 21, further comprising providing a respective subtree for each bucket to which more than one data element is assigned.

23. The method of claim 22, further comprising arranging data elements that store multidimensional data by interleaving bits of numbers in one dimension with bits of numbers in each of the other dimensions.

24. The method of claim 21, wherein the types of numbers include special numbers and non-special numbers, and wherein the method further comprises assigning a respective subtree to each bucket for which the combined TLE includes at least one TLE for a non-special number.

25. The method of claim 24, further comprising arranging data elements that store multidimensional data by removing dimensions containing special numbers from the data elements and interleaving bits of numbers in one unremoved dimension with bits of numbers in each of the other unremoved dimensions.

26. The method of claim 3, further comprising compacting the tree to remove unused buckets and counts.

27. The method of claim 3, wherein traversing the set of nodes to generate the histogram of the data elements counted by the set of nodes includes:
receiving a query that requests a total count of all data elements between a first data element and a last data element;
establishing an initial running total based at least in part on a set of first-leaf counts appearing in a first leaf node after a first count associated with the first data element;
adding to the running total a set of last-leaf counts appearing in a last leaf node before a last count associated with the last data element;
adding to the running total at least one aggregated count obtained from a lowest common node at a level of the tree higher than the first leaf node and the second leaf node; and
returning the running total in response to the query.

28. The method of claim 1, wherein a multi-bit sorting value precedes the plurality of consecutive chunks in the uniform data format, and wherein the method further comprises providing, for each unique sorting value of data elements that are filed, a pointer to a root node of a respective tree, each respective tree constructed and arranged to file data elements having the sorting value as its most-significant bits.

29. A computerized apparatus, comprising control circuitry that includes a set of processors coupled to memory, the control circuitry constructed and arranged to:
provide a plurality of data elements in a uniform binary format that represents each data element as including a plurality of consecutive chunks, each chunk defining a sequence of consecutive binary digits;
place the plurality of data elements in nodes of a tree based on the plurality of chunks, the nodes of the tree arranged in successive levels that correspond to successive chunks of the plurality of chunks, each node counting data elements placed in that node and in any child nodes of that node at lower levels of the tree; and
traverse a set of nodes of the tree to generate a histogram of the data elements counted by the set of nodes.

30. A computer program product including a set of non-transitory, computer-readable media having instructions which, when executed by control circuitry of a computerized apparatus, cause the computerized apparatus to perform a method of generating histograms, the method comprising:
providing a plurality of data elements in a uniform binary format that represents each data element as including a plurality of consecutive chunks, each chunk defining a sequence of consecutive binary digits;
placing the plurality of data elements in nodes of a tree based on the plurality of chunks, the nodes of the tree arranged in successive levels that correspond to successive chunks of the plurality of chunks, each node counting data elements placed in that node and in any child nodes of that node at lower levels of the tree; and
traversing a set of nodes of the tree to generate a histogram of the data elements counted by the set of nodes.
